(19) United States
(12) Patent Application Publication
(10) Pub. No.: US 2014/0341449 A1
(43) Pub. Date: Nov. 20, 2014

(54) COMPUTER SYSTEM AND METHOD FOR ATLAS-BASED CONSENSUAL AND CONSISTENT CONTOURING OF MEDICAL IMAGES

(71) Applicants: Hamid Reza Tizhoosh, (US); Farzad Khalvati, Richmond Hill (CA)

(72) Inventors: Hamid Reza Tizhoosh, Waterloo (CA); Farzad Khalvati, Richmond Hill (CA)

(21) Appl. No.: 14/344,946

(22) PCT Filed: Sep. 24, 2012
(86) PCT No.: PCT/CA2012/000889

§ 371 Date: Mar. 14, 2014

Related U.S. Application Data
(60) Provisional application No. 61/538,484, filed on Sep. 23, 2011.

(51) Int. Cl. G06T 7/00

(52) U.S. Cl. CPC G06T 7/0083; G06T 2207/20081; G06T 2207/20104; G06T 2207/20128
USPC 382/128

(57) ABSTRACT

A system and method are disclosed to provide a solution to automatically generate consensual and consistent segmentation results to reduce the effects of inter- and intra-observer variability in contouring medical images, respectively. The invention may be used by multiple users with access to an internal or external network or via cloud-computing devices but it does not require having instant access to multiple users for generating the consensus or consistent contours. The invention is applicable on a multitude of medical image modalities such as CT, MRI, Ultrasound, PET and fused images.

### FIELD OF INVENTION

This invention relates in general to the field of atlas-based auto-contouring of medical images. This invention also relates to computer systems for enabling contouring of atlas-based medical images.

### BACKGROUND OF THE INVENTION

Contouring is the word used to describe segmenting/delineating/marking a region of interest, ROI (lesion, organ, and tissue type) in a medical image (CT, MR, Ultrasound, PET etc.). Contouring is a necessary task in many diagnostic, interventional, treatment planning, and post-treatment procedures. Manual contouring is widely used for delineating lesions; the clinical expert uses the computer mouse and clicks around the region of interest to construct the contour.

In contouring medical images, there is generally no “gold standard”, meaning that there is generally no 100%-accurate contour for a given lesion/organ of a given patient. Different experts (radiologists, oncologists, pathologists etc.) contour differently. This well-known dilemma which has been known since the 1950s is called “inter-observer variability” and constitutes a serious impediment to quality assurance in medical image analysis (see “Observer variation in the tomographic diagnosis of tuberuculous cavitation”, Gandevia B., Stradling P., Tubercle 1957, 38:113-22. The so-called inter-observer variability is sometimes so drastic that “observers agree on only 50% of the total delineated volume” (“Inter-observer variability of clinical target volume delineation for bladder cancer using CT and cone beam CT”, F. Foroudi, A. Haworth, A. Pangehel, J. Wong, P. Roxby, G. Duchesne, S. Williams and K. H. Tai, Journal of Medical Imaging and Radiation Oncology 53 (2009) 100-106 and in other cases the agreement can even drop to 40% (“Inter-observer comparison of target delineation for MRI-assisted cervical cancer brachytherapy: Application of the GYN GEC-ESTRO recommendations”, Johannes C. A. Dimopoulos, Veronique De Vos, Daniel Berger, Primoz Petric, Isabelle Dumas, Christian Kirisits, Carey B. Shenfield, Christine Haie-Meder, Richard Potter, Radiotherapy and Oncology 91 (2009) 166-172).

The same problem also applies to individual experts when they mark the same image differently when they process it after a while. This is often called “intra-observer variability”. Generally, the variability in contouring originates from the subjective nature of the task that, in spite of all the anatomical knowledge of the experts, it still causes alterations and inconsistencies to occur.

Various technologies are known for providing atlas-based segmentation of medical images. Technologies are also known that enable binary and/or quasi-binary atlas-based auto-contouring of volume sets in medical images.

For example, PCT/CA2012/000353 of the present inventors provides a “METHOD AND SYSTEM FOR BINARY AND QUASI-BINARY ATLAS-BASED AUTO-CONTOURING OF VOLUME SETS IN MEDICAL IMAGES” (the “Prior PCT Application”).

For many applications, for example medical diagnosis, it is useful to provide mechanism that enable two or more medical professionals to form a consensus regarding contouring of medical images.

The concept of consensus contouring of medical images is known in the prior art.

For example, U.S. Pat. No. 7,995,813, issued to Foshee and Chao, relates to: “Reducing Variation in Radiation Treatment Therapy Planning” (“Foshee”). Foshee proposes a solution for reducing the variation among doctors with respect to contouring of medical images. Specifically Foshee suggests connecting multiple experts to receive their markings/contours in order to generate a consensus contour. In other words, the actual contouring of the experts who are connected via a medium is used to create consensus contours. In general, Foshee discloses a computer network system that implements the consultation based methods that are used by clinicians in practice that is, consulting one or more colleagues in order to remove uncertainty in contouring by engaging in live or virtual discussions with one another.

The solution proposed in Foshee requires significant resources and may not be scalable.

Improved mechanisms for generating consensus contours are required.

### SUMMARY OF THE INVENTION

In one aspect of the invention a computer implemented automated method for reducing inter-observer variability or intra-observer variability in contouring medical images is provided comprising: (A) linking to a computer system, via a computer network, one or more centralized or decentralized atlases of images and associated contours; (B) a user creating a contour for a new image, using a contouring tool linked to the computer system; (C) the user requesting a consensus contour or consistency contour using a consensus/consistency contour generator linked to the computer system, optionally based on one or more user defined parameters; (D) the computer system initiating a search of the atlases of images, or a subset of the atlases of images, to find a set of matching images similar to the new image based on one or more similarity criteria, the computer system optionally registering the similar images in association with the new image in a data store linked to the computer system; (E) the consensus/consistency contour generator building a consensus contour using at least N contours from N users, or a consistency contour from N contours from the user, from the matching images by combining the N contours to form a consensus contour; and (F) presenting the consensus contour or the consistency contour to the user for supporting one or more user contouring operations in a manner that reduces intra-observer variability or inter-observer variability in contouring medical images, by utilizing the computer system built consensus contour.

In another aspect of the invention, the user defines one or anomalies or clinical cases, and based on the anomalies or clinical cases, the computer system (A) identifies a group of similar images in the atlases, and their associated contours, and (B) generates an aggregation of the contours for the similar images so as to produce the consensus contour or the consistency contour.

In another aspect, the contours are aggregated by reconciling differences between the contouring actions of the different users who generated the similar images, or the same user who generated the similar images.

In a still other aspect, the method comprises the further step of calculating agreement/deviation measures, such as sensitivity, specificity and conformity, and displaying these measures for the user, thereby permitting the user to evaluate the degree of deviation of the user created contour from the consensus contour or the consistency contour.

In another aspect, the method comprises the further step of automatically and continuously updating/enlarging an atlas set for each user of the server computer.

In a still other aspect, where the method is adapted to reduce intra-observer variability in contouring medical images, wherein personalized atlases for each user are created and made available by the computer system, including atlases that include gray-intensity or binary or quasi-binary representations of images or parts of them, along with the associated the user-approved contours, and wherein the atlases are stored using a central computer or a distributed architecture linked to the computer system: (A) the consensus contour or the consistency contour is requested by the user for consistency verification of the contour created by the user; and (B) the use of the consensus contour built by the system provides automated consistency verification.

In another aspect, the consensus/consistency contour generator enables the extraction of contouring insights, and the computer system enables contouring decision support by presenting the results of the contouring insights in connection with the user image contouring actions.

In a still other aspect, a computer system for reducing inter-observer variability or intra-observer variability in contouring medical images is provided comprising: (A) a server computer linked to one or more centralized or decentralized atlases of images and associated contours; and (B) a consensus/consistency contour generator utility implemented to, or linked to, the server computer; wherein the contour generator utility enables: (i) a user to create a contour for a new image, using a contouring tool, or import a user created image contour; (ii) the user to request a consensus contour or a consistency contour, and define one or more parameters associated therewith; (iii) a search of the atlases of images, or a subset of the atlases of images, to find a set of matching images similar to the new image based on one or more similarity criteria, and optionally registration of the similar images to a data store linked to the server computer; (iv) the generation of a consensus contour using at least N contours from N users, or a consistency contour from N contours from the user, from the matching images by combining the N contours to form a consensus contour, regardless of the image modality of the images associated with the N contours; and (v) presentation of the consensus contour or the consistency contour to the user for supporting one or more user contouring operations in a manner that reduces intra-observer variability or inter-observer variability in contouring medical images by utilizing the computer system built consensus contour.

In another aspect, a computer system if provided wherein the user defines one or more anomalies or clinical cases, and based on the anomalies or clinical cases, the computer system (A) identifies a group of similar images in the atlases, and their associated contours, and (B) generates an aggregation of the contours for the similar images so as to produce the consensus contour or the consistency contour.

In another aspect of the computer system, the contours are aggregated by reconciling differences between the contouring actions of the different users who generated the similar images, or the same user who generated the similar images.

In a still other aspect, the contour generator utility is further operable to calculate agreement/deviation measures, such as sensitivity, specificity and conformity, and display these measures for the user, thereby permitting the user to evaluate the degree of deviation of the user created contour from the consensus contour or the consistency contour, wherein this information enables guidance of contouring decisions of the user.

In another aspect, personalized atlases for each user are created and made available by the computer system, including atlases of gray-intensity or binary or quasi-binary representations of images or parts of them, along with the associated the user-approved contours, and wherein the atlases are stored using a central computer or a distributed architecture linked to the computer system, wherein: (A) the consensus contour or the consistency contour is requested by the user for consistency verification of the contour created by the user; and (B) the use of the consensus contour built by the system provides automated consistency verification.

In another aspect of the invention, the contour generator utility enables the extraction of contouring insights across multiple users and presentation of the contouring insights in connection with the user image contouring actions.

In a still other aspect of the invention, a learning utility is provided that is operable to analyze contouring actions and/or contouring preferences of the user in order to improve the matching of the user created image/contour to available to available images/contours based on relevancy.

In yet another aspect, the contour generator utility is associated with a viewing/editing dashboard that enables the user to generate more accurate contours, including by using one or more intelligent features integrated to the dashboard that are linked to the learning utility.

### DESCRIPTION OF THE DRAWINGS

FIG. 1 illustrates a conventional atlas.

FIG. 2 illustrates a binary atlas.

FIG. 3 illustrates the details of creating an atlas for User X by manual segmentation of a series of images.

FIG. 4a illustrates a possible implementation of the computer system of the present invention.

FIG. 4 illustrates a centralized collection of multiple atlases stored on a central storage device in a private or local network or accessible via cloud computing.

FIG. 5 illustrates distributed (decentralized) collection of atlases.

FIG. 6 illustrates building consensus contours via contours retrieved from centralized or decentralized atlases of multiple (different) users.

FIG. 7 illustrates the details of automated generation of a consensus contour for User X.

FIG. 8 illustrates building consensus contour via contours retrieved from the atlas of the user to deliver consistent contours.

FIG. 9 illustrates the details of automated verification of contouring consistency for User X.

FIG. 10 further illustrates a possible implementation of the computer system of the present invention.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE INVENTION

In one aspect of the invention computer implemented methods, and a computer system, are provided for generating automatically consensus contours using atlas-based medical images in order to verify the contouring consistency of clinical users.

This disclosure discusses two principal applications of the automated consensus contouring technology described herein. A first application enables a clinical expert to verify his/her own contouring in relation to one or more particular atlas-based medical images by accessing one or more atlases and generating a consensus contour using contouring of similar images previously completed by the same clinical expert. This application provides a novel and innovative solution for reducing intra-observer variability.

In a second application, one or more users request the generation of a consensus contour using in relation to one or more particular atlas-based medical images by accessing one or more atlases and generating a consensus contour using contouring of similar images previously completed by a group of clinical experts. This aspect of the present invention provides a novel and innovative solution for reducing inter-observer variability. The system has been configured so that consensus contours may be generated across different modalities of medical images, e.g. CT, MR, Ultrasound, PET etc., including by utilizing atlas-based auto-contoured medical images described in the Prior PCT Application.

The present invention provides a computer network implemented system and computer implemented methods that enable the automatic generation of consensus contours without the need to connect multiple experts relative to the same patient or medical image. Prior art solutions generally require simultaneous availability of multiple experts (who may be connected using a network connection for example) in order to generate a consensus contour. This may not be practical, and also requires the investment of significant resources from medical experts who are very busy. The present invention, in contrast, enables users to leverage the collective expertise and experience of a group of medical experts, by providing a novel and innovative technology framework and computer network framework that enables the extraction and integration of knowledge from contouring previously completed by a group of medical experts.

The computer system and computer implemented methods provide represent a significant innovation over prior art approaches that are mostly manual (one medical expert showing a medical image/contour to another), and do not leverage the opportunity to automate and leverage more relevant expertise (for example outside of established networks and available personal consultations) by leveraging broader resources and expertise using a cloud network.

In contrast to prior art solutions, the present invention discloses an automated system that, at the time of the consensus generation does not require input from experts, and rather generates contours “on behalf” of experts by means of search and recognition of available atlases across a plurality of experts. More particularly, the present invention includes an automated consensus contour generator component that may incorporate one or more machine learning methods or components for implementing learning from each expert (constructing large atlases for each of them) in order to fully automatically (and in absence of all experts) extract and display consensus contours, based on a request from a user.

The present invention allows a user to (A) send a request to the computer system of the present invention for creation of an atlas based on (i) one or more modalities, and/or (ii) for one or more user specified anatomies/clinical cases; (B) based on the request the computer system accesses a plurality of atlas-based images associated with one or more databases linked to the computer system, and as described below, generates an aggregation of contours made for similar medical images (based on the modalities and/or the user specified anatomies/clinical cases) created by the user, a group of other users, or a group of users including the user and other users; and (C) the computer system provides access to the user (or one or more systems) to the aggregation of contours.

The invention can generate contours by searching in atlases of one or more users, made for example in accordance with the Prior PCT Application, by finding the most similar case to a new image in one or more linked atlases the atlas and registering a consensus contour with the new image.

As previously stated, in one aspect of the invention, a system, apparatus and method is provided that enables the generation of multiple contours by accessing multiple atlases created by different users. For N users, the invention can generate for example at least N contours from N available atlases.

A consensus contour is generated by the present invention (may also be referred to in this disclosure as a “true contour” or “gold standard contour”) that reconciles the differences between all users. More particularly the computer system of the present invention generates the aggregated contour based on reconciliation of differences between the contouring actions of other users. A skilled reader will appreciate that the higher the number of users, the more trustworthy the consensus contour becomes such that it can be seen as “true contour”.

In one aspect of the invention, a first user requests a consensus contour and the system of the invention is operable to obtain contours made for similar image content by one or more other users, from one or more other associated computers, based on atlases used previously by such one or more other users.

In another aspect of the invention, the invention can generate multiple contours by accessing one or multiple atlases created by the same user. For the requesting user, the invention will generate M contours from corresponding atlas(es) of that user. The present invention may generate one or more “consistent” contours in that the system reconciles the differences between all possible contours extracted from the atlas(es) of the same user. A skilled reader will appreciate that the larger the atlas(es) of that user, the more trustworthy the consistent contour becomes.

In another aspect of the invention, the method, apparatus and system of the present invention is operable to enable the generation of a consistent contour automatically upon receiving a request from any user.

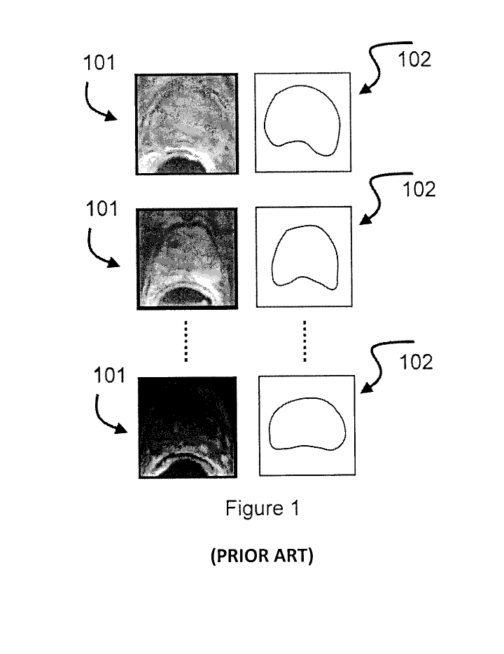

FIG. 1 illustrates a prior art atlas for organizing medical images. An atlas generally consists of images or image thumbnails (101) that include regions of interest (also referred to as ROIs) (such as tumour/organs). FIG. 1 also shows (in the right hand column) associated representations of corresponding segments/contours (102) created/approved by a specific user. Images or thumbnails (101) are generally gray-level images (8 or more bits), and may have been normalized and resized (usually down-sampled). An atlas may be generated (for example by an expert user) using an appropriate computer system that may include one or more components or features that enable contouring of the images, as described below.

“Contouring” in medical imaging refers to determining the anatomical boundaries of an organ, lesion (tumour), or tissue type by drawing lines (contours) along the boundaries thereof. Contouring is an important part of many different tasks across different medical fields, including: (A) making diagnostic measurements of organs/tumours (e.g. shape/volume measurements in radiology), (B) marking a lesion/tumour for treatment (e.g. radiation treatment in oncology), (C) gaining more knowledge about a disease (e.g. in pathology or research), or (D) tracking the effect of a drug in eliminating a disease (e.g. pre-clinical animal imaging).

The Prior PCT Application discloses a possible mechanism for generating the contours (102) illustrated in FIG. 1.

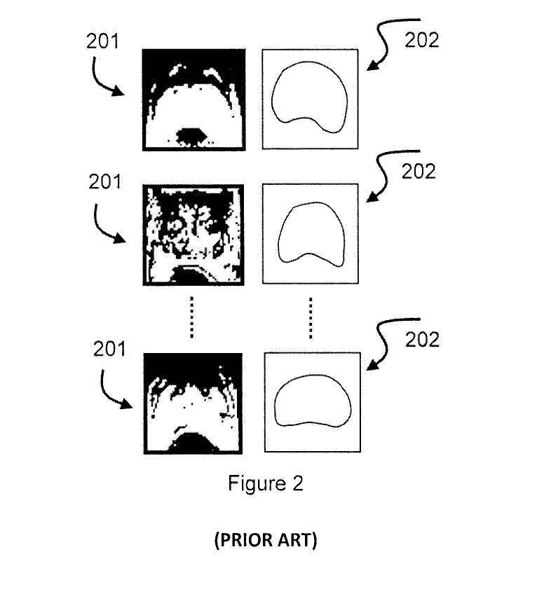

FIG. 2 illustrates a binary atlas. A binary atlas generally consists of binary codes representing images or image thumbnails (ROIs) (201) and the corresponding segments/contours (202) created/approved by a specific user. A skilled reader will understand that these binary codes (201) may be generated using different mechanisms, based on images or image thumbnails (ROIs). The main advantage of a binary atlas (as well as a quasi-binary atlas) is that it allows for a fast search compared to a conventional atlas.

A skilled reader will appreciate that the present invention may utilize the images or thumb nails, as shown in FIG. 1, or the binary codes shown in FIG. 2. In either case, the invention may rely on the auto-contouring described in the Prior PCT Application.

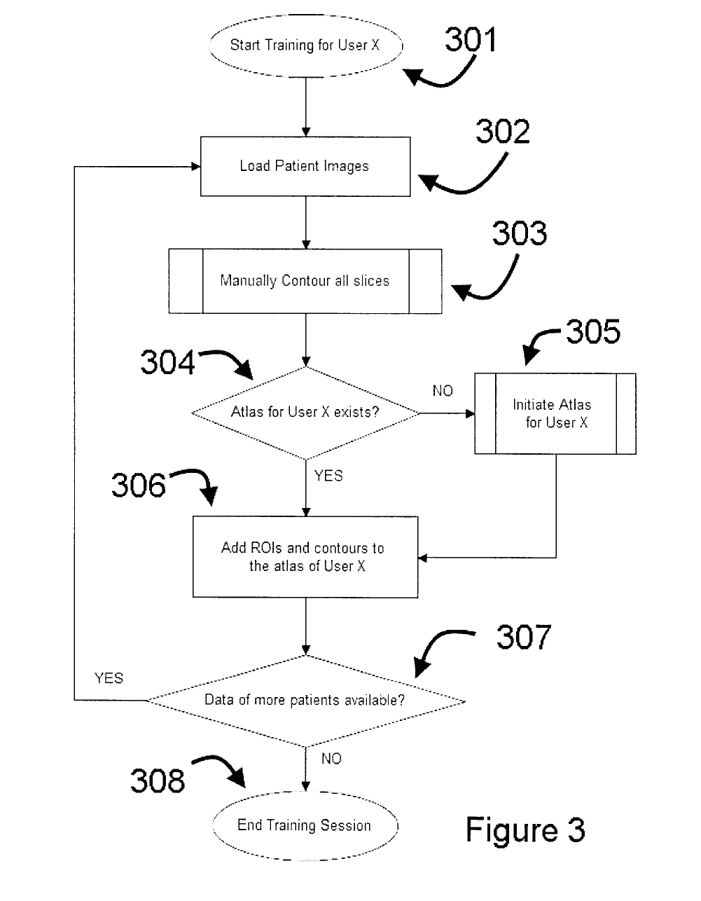

FIG. 3 illustrates a possible method of creating an atlas for User X by manual segmentation of a series of images. Dealing with N users, an atlas can be created for each User X (FIG. 3). Atlas creation (301) starts with loading patient images (302) and manual contouring by User X (303). If the user has no previous atlas (304) then a new one is created (305), and the region of interest (ROI) (or its representative features) and contour will be added to the atlas (306). These steps are repeated for all patients whose images are available (307). At the end of the training session an atlas for User X has been created (308).

Searching in these personalized atlases, and updating these atlases, is described in the Prios PCT Application.

### System Implementation

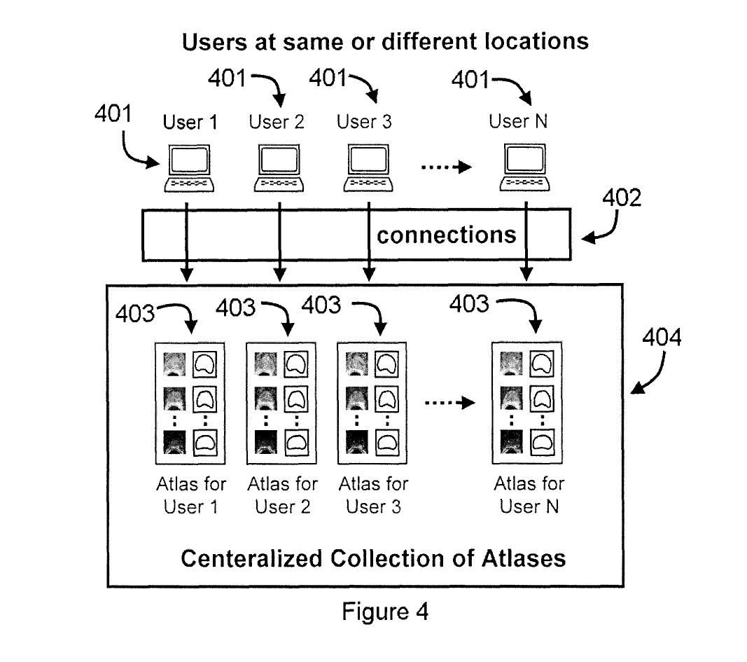

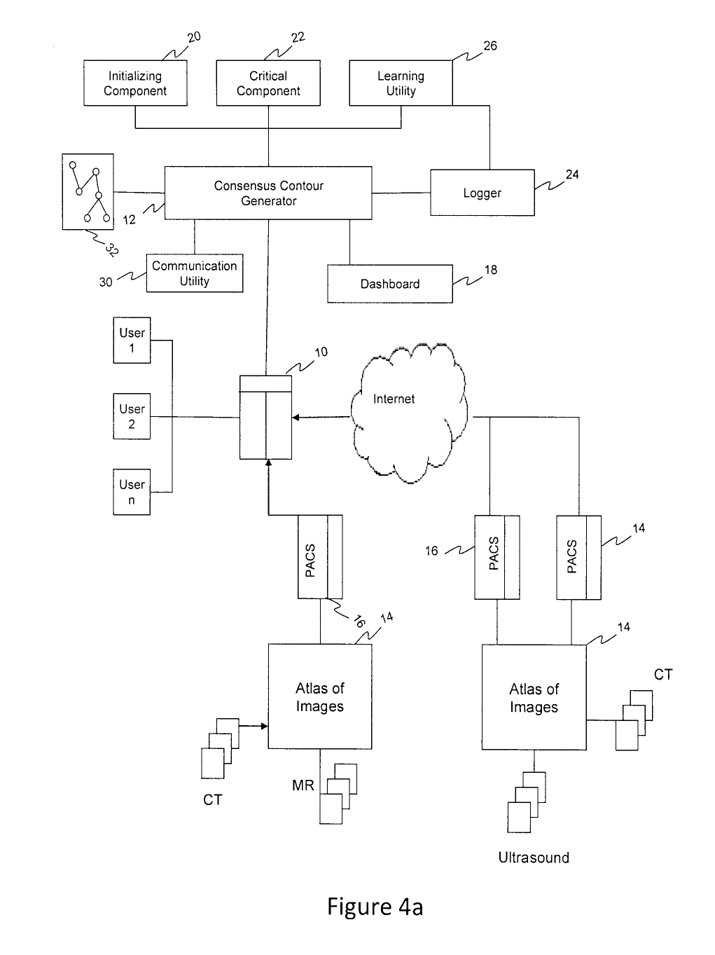

In one aspect of the invention, a medical image visualization/editing computer system if provided that includes quality assurance functionality based on consensus contouring features. One implementation of the invention is illustrated in FIG. 4a. A computer system (8) is shown that provides improved quality assurance in various processes that depend on medical images such as diagnostic, interventional, treatment-planning and post-treatment monitoring of any disease/illness/malignancy, if digital imagery is involved.

In the implementation of the invention shown in FIG. 4a, a computer (10) is provided. The computer (10) is associated with a consensus contour generator (12) of the present invention. The computer (10) is configured to access one or more atlases of images (14). In the implementation shown in FIG. 4a, the computer (10) is linked to one or more PACS servers (16), as further explained below. A PACS server (16) may be linked to the computer (10), also the computer (10) may access one or more other PACS servers (16) via the Internet (configured to accept requests from the computer (10)), thereby enabling the computer (10) to leverage broader resources of a cloud network that includes one or more PACS servers (16).

The consensus contour generator (12) includes or links to a visualization/editing dashboard (18). A skilled reader will understand that various configurations of the dashboard (18) are possible depending on the specific application of the present invention.

A shown in FIG. 4a, the consensus contour generator (12) includes: (A) an initializing component (20) for enabling the determining of one or more parameters associated with the visualization/editing of medical images by the user, and other aspects of initialization of the system; (B) a retrieval component (22) that is configured, based on the parameters, to communicate with one or more other computers (which may include a PACS server (14) depending on the system configuration) systems or databases associated with the atlases (14), to initiate the retrieval of a plurality of relevant contour associated with particular medical images, as explained below.

In a further aspect, initialization may involve collecting parameters for defining relevant images. This may include for example the type of anatomy/anomaly, or the purpose of the contouring. Initialization may involve determining other parameters for filtering which images are relevant. For example, it may be useful to limit the use of images/contours generated by specific users for example, or users having particular designations, or users having a “trust score” that defines a particular threshold.

In one aspect of the invention, the retrieval component (22) enables the computer system (10) to connect to one or more remote resources via a network of computers such as the Internet, as shown in FIG. 4a. The computer system (10), interoperating with the one or more remote resources, is configured to enable the user to access a cloud network in order to leverage the expertise of other users by means of their contouring of relevant medical images.

Significantly, the computer system (10) includes a series of features and functions that enable the management of resources available via the cloud network in an intelligent manner. One contribution of the invention, is the discovery of the network architectures described herein which are novel and innovative per se.

A skilled reader will understand that the computer system (10) enables a user to access the cloud network in order to crowd source tasks involving the contouring of medical images. The computer system (10) enables users to access crowd resources for enabling the use of medical images with improved quality assurance.

In one aspect of the invention, the computer system (10) includes a logger (24) that is operable to log actions of the user. The logger (24) is linked to a learning utility (26) which may implement one or more machine learning operations. A skilled reader will appreciate that various machine learning techniques may be used. The learning utility (26) may be configured to learn for example a user's contouring preferences or habits. These preferences may be used to update a profile associated with the user, and this profile may be used to automate certain aspects of the initialization process described above. The preferences may relate to how a user performs a particular contour, and/or may also relate to parameters associated with initialization as mentioned above. This may contribute to streamline aspects of the computer implemented method of the present invention, and may make the features of the dashboard (18) more intuitive. This may also improve the filtering of images/contours available to the system, based on relevancy.

In one implementation, the dashboard (18) may include or link to a number of tools that enable a user to for example (A) view one or more medical images, including optionally one or more contours generated by the user, (B) view a consensus contour relevant to the medical images and/or user generated contour(s), and (C) optionally edit the user contours based on the consensus contour. In one possible implementation for example, the dashboard (18) may permit the user to request the integration of the consensus contour with the user generated contour so that the user may compare the user generated contour with the consensus contour generated by the computer system (8). A skilled reader will understand that these are only examples of the various interactive features that may be made part of the computer system (8) and that may be accessed using the dashboard (18).

As a further aspect, the computer system (8) may include functionality for integrating automatically into the one or more medical images a system generated consensus contour so as to provide a system suggested contour.

The computer system (10) may also include a communication utility (30) that enables for example users to communicate with one or more remote users in conjunction with contouring activities for example to seek advice or ask questions regarding a particular instance of contouring. In one implementation, the communication utility (30) may include for example instant messaging features thereby enabling a first user of the computer system to send a communication to a second user of the computer system. The present invention enables new connections to be created between users based on similarity of contouring completed in the past, detected automatically by the system. This enables connections to be made outside of currently available consultation networks in a convenient and automated fashion.

The dashboard (18) may include one or more features that enable a user to configure one or more parameters for defining how the user wishes to leverage the resources (such as expertise) available through the computer system (18). For example, the computer system (10) may include or link to a social media utility (32) that includes one or more social networking functions, that may enable the user to “follow” certain other individuals or groups whom the user deems to have relevant expertise. The social media utility (32) may enable users to determine a user's “trust score”. These features and functions may enable the user to filter the contours used from the atlases (14) depending for example on the particular users who may have generated them. A skilled reader will appreciate that the social media utility (32) may leverage the features of established social networks or may be used to provide a special purpose, proprietary social network dedicated to social interactions related for example to medical diagnosis, across one or more participating organizations and their staff.

A significant contribution of the invention, is that the consensus contouring features of the present invention are provided regardless of the modalities of different atlases (14) associated with the present invention. For example, atlases (14) may include one atlas with images in one format, whereas another atlas may include images in a completely different format. As previously described, medical images that may be useful in that they contain or are associated with relevant contouring in relation to similar images, may exist in a variety of modalities such as MR, CT, PET, Ultrasound etc.

As shown for example in FIG. 4a, the atlases (14) may be generated and stored using one or more systems for archiving and accessing medical images.

The computer system (10) of the present invention is typically connected to one or more picture archiving and communication systems or PACS. These systems are designed to enable economic storage of, and retrieval of, images using a plurality of network-connected devices. A PACS is typically based on a standard format that enables the storage and retrieval of images. A PACS (16) typically includes: (A) a central server; (B) one or more workstations that provide means for generating an interactive display of digital images, including a viewer; (C) a database system responsible for managing the storage of medical images and associated information in the PACS (16); (D) a DICOM server responsible for DICOM based communications with imaging modalities (such as CT and MRI), other PACS servers and DICOM workstations; and (E) optional interfaces to health information systems.

Optionally the retrieval component (22) includes remote access features to connect to the PACS (16).

In another implementation of the present invention the computer system (10) includes a search and registration component (32) that is operable to register to the computer system (10) similar images found in an atlas (16) and also an associated contour. A skilled reader will understand that a rigid or non-rigid registration algorithm can be employed for detection/alignment to the best matching image/contour. Various other mechanisms may also be used.

A skilled reader will appreciate that various network architectures are possible for providing the consensus contouring features of the present invention.

For example, FIG. 4 illustrates a centralized collection of multiple atlases stored on a central storage device in a private or local network or accessible via cloud computing. The atlases of multiple users can be stored on a central storage device in a private or local network or accessible via cloud computing. The decentralized storage of created atlases enables the consensus contouring to be accessible to a larger number of users, e.g. all experts working in a hospital or a group of associated hospitals, or, all experts that subscribe to a cloud storage service.

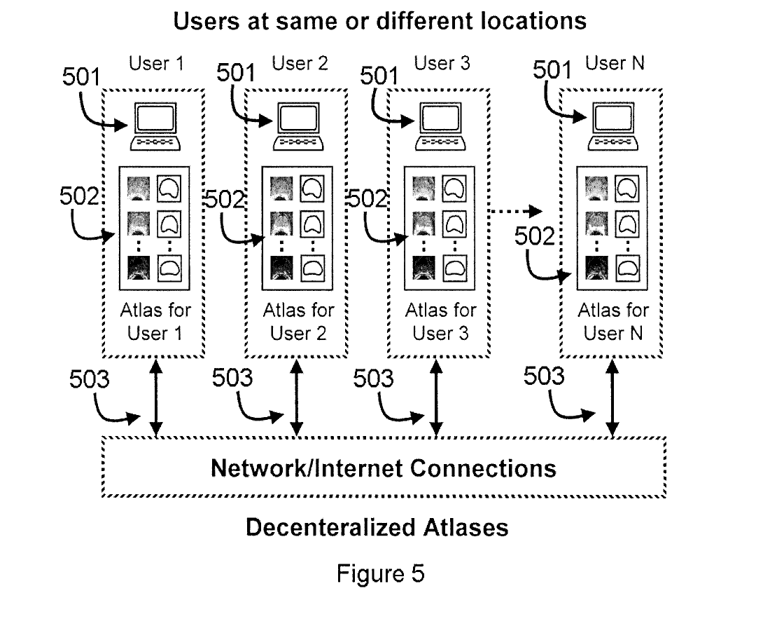

FIG. 5 illustrates distributed (or decentralized) collection of atlases. The atlases of multiple users can be stored on each personal computer or workstation of each user and can be accessed via network connections, which may be initiated by the computer system (10). In this scenario, every expert keeps their own atlas(es) on their own computer for example. The expert can still share their atlases with each other by uploading/downloading of available atlases.

Atlases of multiple users can be stored and managed in a central location, as shown in FIG. 4). The invention can accommodate N users (401) each working at the same or in different locations but connected (402) to the centralized collection (404), of all individual atlases (403).

Atlases of multiple users can be stored on their own computers in different locations (as shown in FIG. 5). The invention can accommodate N users (501), each working at the same or in different locations but connected to each other (503), with access to all distributed individual atlases (502).

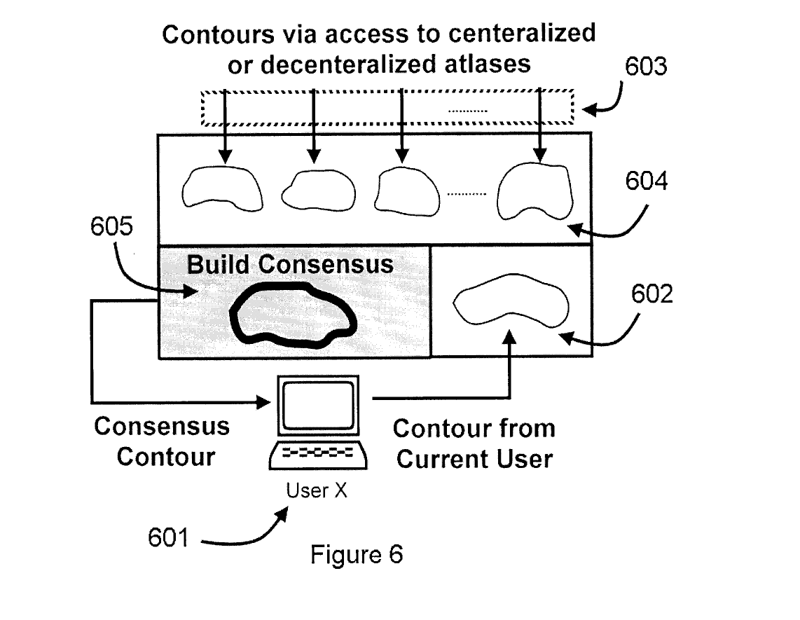

FIG. 6 illustrates that the computer system of the present invention may interoperate with both centralized or decentralized atlases of multiple (different) users. To build a consensus contour, multiple contours of multiple users can be retrieved along with the current contour of the current user. Each contour may be generated by search and registration in individual atlases of different users (accessible via network connections regardless whether centralized or decentralized). The Current User may provide a contour and request consensus contour to verify the correctness of his/her contour (attempting to reduce inter-observer variability by comparing his/her own contour with the consensus contour). All contours generated from all atlases may then be combined to generate a consensus contour and displayed to the Current User.

The invention can build a consensus contour for any arbitrary User X (FIG. 6). The User X (601) contours a new image (602). Via available connections to centralized or decentralized atlases (603), multiple contours may be generated using the atlases of remaining N−1 users (604).

Using the N contours (one from User X, N−1 generated from N−1 atlases of N−1 other users), a consensus contour can be built (605).

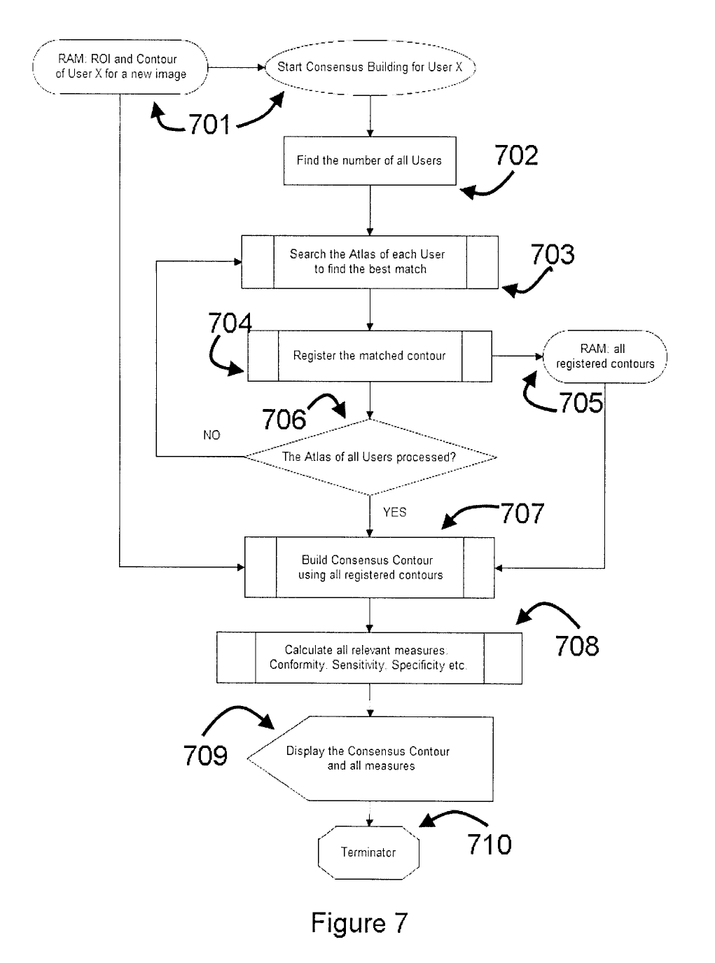

FIG. 7 illustrates a possible mechanism for consensus building in accordance with the present invention. The ROI and contour of User X for a new image is available to start consensus building (701). The number of all available users (which is the number of all available atlases) will be determined (702), as this may change continuously. Each atlas of each user will be searched for the best match with the current ROI (703), and the matched contour(s) is registered using a non-rigid deformable registration (704), and placed in the RAM memory (705), until all atlases of all users have been processed (706). The consensus contour can be subsequently built using N contours (707); using one contour provided by the User X (701), and N−1 registered contours in RAM memory (705). Relevant measures such as sensitivity, specificity and conformity index can be calculated (708), to quantify the deviation of the User X with the consensus contour, using a variety of different mechanisms or known algorithms, as will be readily apparent to a skilled reader. Displaying the consensus contour and relevant measures (709) marks the termination of the consensus building (710).

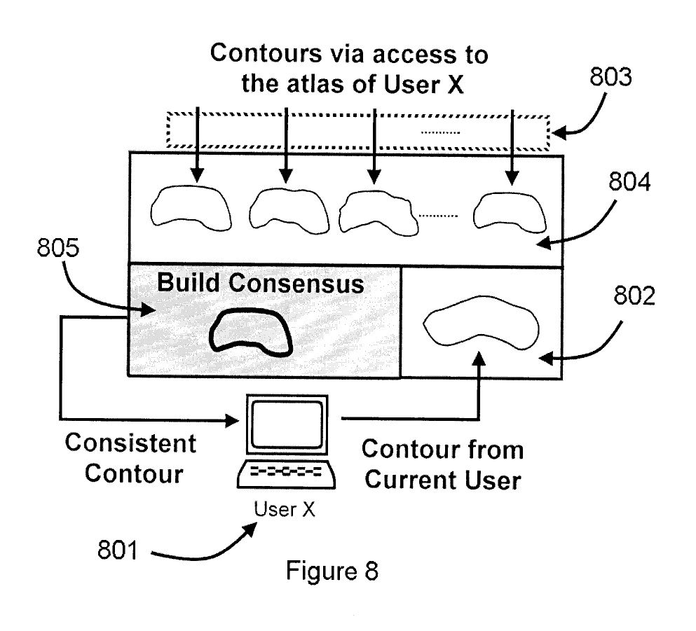

The invention can build a consistent contour for any arbitrary User X (FIG. 8). The User X (801) contours a new image (802}. Via available connections to centralized or decentralized atlases (803), multiple contours are generated using the atlas of the User X (804). Using the M contours (one from User X, M-1 generated from his own atlas), a consensus contour can be built (805). The consensus of User X with himself is a consistent contour.

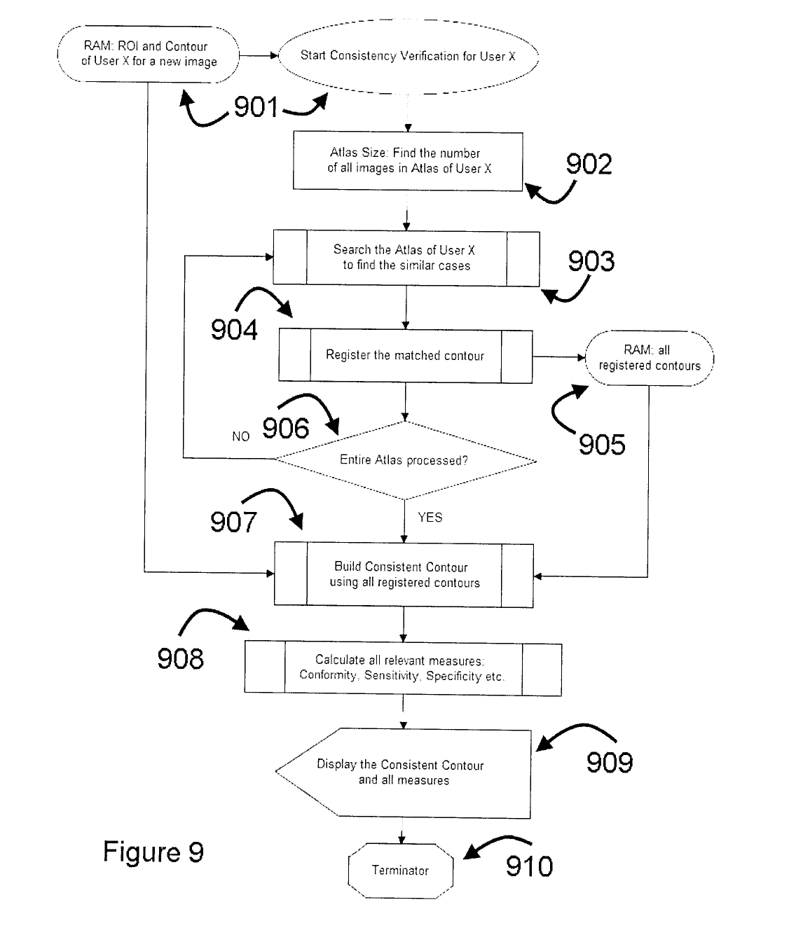

FIG. 9 illustrates a possible mechanism for consistency verification in accordance with the present invention. The ROI and contour of User X for a new image is available to start consistency verification (901). The atlas size (which is the number of all available images in that atlas) will be determined (902), as this may change continuously. The atlas of User X will be searched for similar cases with the current ROI (903), and the matched contour may be registered using a non-rigid deformable registration (904), and placed in the RAM memory (905), until the entire atlas of User X has been processed (906). The consistent contour can be subsequently built using M contours (907); using one contour provided by the User X (901), and M−1 registered contours in RAM memory (905). Relevant measures such as sensitivity, specificity and conformity index can be calculated (908) to quantify the deviation of the User X with the consistent contour. Displaying the consistent contour and relevant measures (909) marks the termination of the consensus building (910).

A skilled reader will appreciate the computer system and computer implemented method of the present invention provides fully automated generation of consensus contours, which upon a request from a user, and based on information regarding contouring of similar medical images by one or more other users, stored to a database, retrieves one or more consensus contours for enabling the verification of contouring consistency.

The present invention may employ a binary and/or quasi-binary atlas-based approach (as described in the Prior PCT Application), and technology based on this approach, for enabling auto-contouring of medical images based on consensus building.

In one aspect of the invention, the historical contouring data sets obtained by the system relate to contouring by the requesting user. In this way, the atlas of each user over time can grow and converge toward a high agreement with the expert's expectations, in terms of where the contour should be. In that point of convergence, the invention becomes capable of imitating/reconstructing the contouring preferences of each user. Hence, multiple contours can be extracted from multiple atlases, reflecting the individual differences; a consensus contour can be built and offered to each individual user to assess his/her own sensitivity and specificity, as well as conformity index or any other metric/measure to quantify the deviation of each user from the consensus contour. A skilled reader will understand that once the atlas(es) converge, the invention may not require the user input to generate consensus contour. Moreover, based on the degree of the convergence, a confidence measure can be assigned to the generated consensus contour to reflect how reliable the generated contour is.

The present invention generates a personalized atlas for each user. The invention therefore creates and stores to a database a personalized atlas for each user. It is important to understand that a single user or expert, and their past contouring activity plus a registration technique is all that is required to enable auto-contouring or suggestion of an alternate contour, in accordance with the present invention. Also, multiple contouring instances of similar medical images can be gathered by operation of the present invention in order to enable auto-contouring, or suggestion of an alternate contour. The system of the present invention enables the manual generation of a first contour created by one of the users, and one or more other contours are generated automatically based on the method described, and these one or more other contours may be provided to the requesting user, or displayed in conjunction with the manually generated first contour. The system may enable the requesting user to select the particular contour to be used for the particular medical image. The system may be operable to provide consistency verification of the manually generated contour, based on the auto-contouring features described.

The invention can also assist the same user to become more consistent in the way he/she contours. The consistency verification by the invention can offer each expert a consistent contour by employing the atlas of that specific user. In other words, the system of the present invention also provides a learning system that enables the use of the technology by a first user to improve contouring by reference to contouring for similar medical images undertaken by one or more other experts.

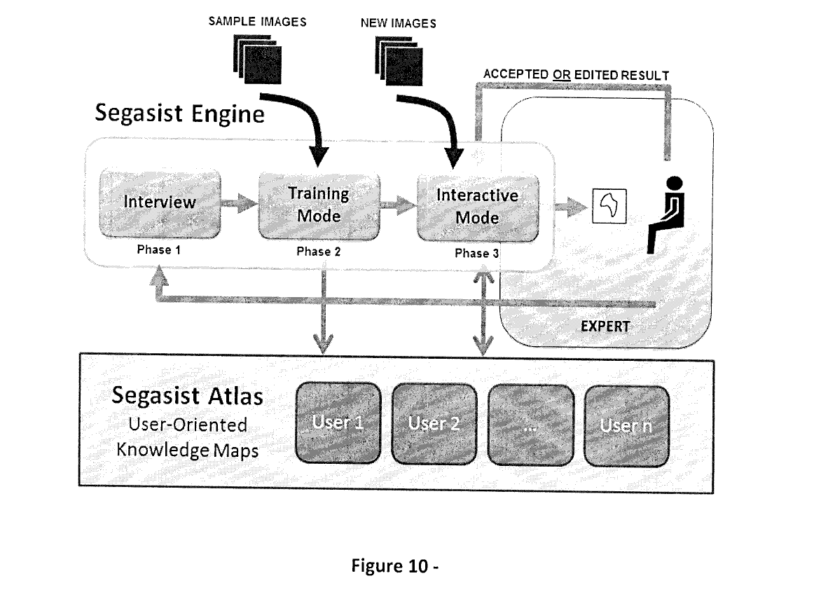

FIG. 10 illustrates that the present invention may be understood as enabling: (A) an interview phase, (B) a training phase, and (C) an interactive phase.

### Computer Implemented Methods

In one aspect of the invention, the method enabled by the present invention may be implemented as follows:

(1) One or more users use the invention to contour images (the invention creates and maintains an atlas for each of them, and stores the atlases to a searchable database as described in the Prior PCT Application).

(2) An individual user is trying to contour an image but he/she is not sure about accurate boundaries of the lesion/organ/tissue type, or may want verification of the contour.

(3) The user can request one or more of:
(a) A consensus contour: the invention automatically searches in the atlases of all other users and generates at least as many contours as there are users, based on similarity measures; a consensus can be built (other users do not need to be present or available at their computers),
(b) A consistent contour: the invention automatically searches in the atlas of the same user and generates as many contours as possible based on similarity measures; a consistent contour can be built as consensus of the contours of the same user.

(4) The consensus and/or consistent contour will be displayed to the requesting users.

(5) Quality measures (sensitivity, specificity, conformity etc.) will be calculated and displayed to the requesting user to quantify his agreement/deviation from the consensus.

(6) The requesting user may modify his contour based on the information received.

It should be understood that the system of the present invention is operable to log a user's activities in relation to the computer system, for example, selection of specific contours so as to build a profile of the user's contouring preferences. These contouring preferences may be used to further support the auto-contouring functions described.

In another aspect of the present invention, the method of building a consensus contour consists of the following steps:

(1) Every point of the consensus/consistent contour is the average of the corresponding points of all N contours. The average contour converges toward the “consensus contour” or the “consistency contour” when many atlases are available.

(2) Every point of the consensus/consistent contour is the weighted average of the corresponding points of all N contours where weights can be defined based similarity of individual contours with a median contour.

(3) Every point of the consensus/consistent contour is the result of distance optimization from all corresponding points of all contours to achieve highest possible sensitivity and specificity for each contour.

(4) The consensus/consistent contour may be calculated for example using the known STAPLE algorithm, which is a commonly used mechanism for consensus building in relation to image segmentation: S K Warfield, K H Zou, and W M Wells, Simultaneous truth and performance level estimation (STAPLE): an algorithm for the validation of image segmentation, IEEE Transactions on Medical Imaging 23 (7) (2004) 903-21.

It should be understood that the various contours may be aggregated or combined using a variety of different techniques of which the STAPLE algorithm is one example.

### Possible Applications

A skilled reader will understand that the present invention may be used in conjunction with systems and mechanisms for creating and using atlases of images such as for example in conjunction with the systems and methods for atlas creation, usage and continuous update (learning) described in the Prior PCT Application.

The present invention can be used by various different clinical experts such as for example physicians, radiologists, oncologists, pathologists, medical physicists, dosimetrists, therapists, researchers, qualified technicians and any other qualified personal involved in assessment of digital images of human anatomy.

The present invention can be used for diagnostic, interventional, treatment-planning and post-treatment monitoring of any disease/illness/malignancy if digital imagery is involved.

The present invention can be used for any type of medical images such as Computed Tomography (CT), Magnetic Resonance Imaging (MRI), ultrasound or sonography (US), Positron Emission Tomography (PET), as well as fused or combined modalities or any emerging new modality as long as the image data is available digitally.

A skilled reader will also appreciate that the present invention may be used by one clinical expert (to verify his/her own consistency with the goal of reducing his intra-observer variability) or by multiple clinical experts (to generate a consensus contour with the goal of reducing inter-observer variability).

The invention allows each user to create an atlas for one or more modalities (using the consensus contouring mechanisms describe herein), and for one or more anatomies/clinical cases. Prior PCT Application discloses possible mechanism for creating atlases, using atlases, and continuously updating atlases. Atlases can be stored on the personal computers or workstations of each user, or they can be stored on an internal or external network storage device, or they can be stored on cloud-computing storage devices

The invention can generate contours by searching in atlases of one or more users via finding the most similar case in the atlas and registering the detected contour with the new image. Further details are set out in the Prior PCT Application.

The invention can generate multiple contours by accessing multiple atlases created by different users. For N users, the invention will generate at least N contours from N available Atlases. A consensus contour (also called “true contour” or “gold standard contour”) is the contour that reconciles the differences between all users; the higher the number of users, the more trustworthy the consensus contour becomes such that it can be seen as “true contour”.

The invention can generate multiple contours by accessing one or multiple atlases created by the same user. For the requesting user, the invention will generate M contours from corresponding atlas(es) of that user. A consistent contour is the consensus contour that reconciles the differences between all possible contours extracted from the atlas(es) of the same user; the larger the atlas of that user, the more trustworthy the consistent contour becomes

### Advantages of the Invention

A number of possible advantages of the present invention have been described above, and a person skilled in the art will understand the various and significant advantages of the present invention.

Examples of the advantages of the present invention include:

The present invention enables automated consensus contouring, and therefore helps to reduce inter-observer variability in contouring of medical images.

The present invention incorporates machine learning and therefore enables the development of knowledge by updating atlases such that new cases can be readily handled, thereby decreasing training requirements.

The present invention improves the ability of medical professionals to diagnose accurately, and therefore can operate for any disease/anatomy/malignancy.

Significantly, the present system is designed and configured to enable operation for any modality (CT, MRI, Ultrasound etc.)

The present invention may be used on a single computer, network of computers, or on cloud computing devices, hence, it can act as a platform to access “collective knowledge” of doctors/experts in any given problem/malignancy and for any image modality.

The present invention may be embedded within existing systems as an add-on to provide its benefit. For instance, the present invention can be integrated within PACS systems and any existing CAD and image analytics software.

Various other modifications are possible.

1. A computer implemented automated method for reducing inter-observer variability or intra-observer variability in contouring medical images, characterized in that the method comprises:
(a) linking to a computer system, via a computer network, one or more centralized or decentralized atlases of images and associated contours;
(b) a user creating a contour for a new image, using a contouring tool linked to the computer system;
(c) the user requesting a consensus contour or consistency contour using a consensus/consistency contour generator linked to the computer system, optionally based on one or more user defined parameters;
(d) the computer system initiating a search of the atlases of images, or a subset of the atlases of images, to find a set of matching images similar to the new image based on one or more similarity criteria, the computer system optionally registering the similar images in association with the new image in a data store linked to the computer system;
(e) the consensus/consistency contour generator building a consensus contour using at least N contours from N users, or a consistency contour from N contours from the user, from the matching images by combining the N contours to form a consensus contour; and
(f) presenting the consensus contour or the consistency contour to the user for supporting one or more user contouring operations in a manner that reduces intra-observer variability or inter-observer variability in contouring medical images, by utilizing the computer system built consensus contour.

2. The method of claim 1, wherein the user defines one or anomalies or clinical cases, and based on the anomalies or clinical cases, the computer system (A) identifies a group of similar images in the atlases, and their associated contours, and (B) generates an aggregation of the contours for the similar images so as to produce the consensus contour or the consistency contour.

3. The method of claim 2, wherein the contours are aggregated by reconciling differences between the contouring actions of the different users who generated the similar images, or the same user who generated the similar images.

4. The method of claim 1, comprising the further step of calculating agreement/deviation measures, such as sensitivity, specificity and conformity, and displaying these measures for the user, thereby permitting the user to evaluate the degree of deviation of the user created contour from the consensus contour or the consistency contour.

5. The method of claim 1, comprising the further step of automatically and continuously updating/enlarging an atlas set for each user of the server computer.

6. The method of claim 1, adapted to reduce intra-observer variability in contouring medical images, wherein personalized atlases for each user are created and made available by the computer system, including atlases that include gray-intensity or binary or quasi-binary representations of images or parts of them, along with the associated the user-approved contours, and wherein the atlases are stored using a central computer or a distributed architecture linked to the computer system, wherein:
(a) the consensus contour or the consistency contour is requested by the user for consistency verification of the contour created by the user; and
(b) the use of the consensus contour built by the system provides automated consistency verification.

7. The method of claim 1, wherein consensus/consistency contour generator enables the extraction of contouring insights, and the computer system enables contouring decision support by presenting the results of the contouring insights in connection with the user image contouring actions.

8. A computer system for reducing inter-observer variability or intra-observer variability in contouring medical images, characterized in that the computer system comprises:
(a) a server computer linked to one or more centralized or decentralized atlases of images and associated contours; and
(b) a consensus/consistency contour generator utility implemented to, or linked to, the server computer; wherein the contour generator utility enables:
(i) a user to create a contour for a new image, using a contouring tool, or import a user created image contour;
(ii) the user to request a consensus contour or a consistency contour, and define one or more parameters associated therewith;
(iii) a search of the atlases of images, or a subset of the atlases of images, to find a set of matching images similar to the new image based on one or more similarity criteria, and optionally registration of the similar images to a data store linked to the server computer;
(iv) the generation of a consensus contour using at least N contours from N users, or a consistency contour from N contours from the user, from the matching images by combining the N contours to form a consensus contour, regardless of the image modality of the images associated with the N contours; and
(v) presentation of the consensus contour or the consistency contour to the user for supporting one or more user contouring operations in a manner that reduces intra-observer variability or inter-observer variability in contouring medical images by utilizing the computer system built consensus contour.

9. The computer system of claim 8, wherein the user defines one or more anomalies or clinical cases, and based on the anomalies or clinical cases, the computer system (A) identifies a group of similar images in the atlases, and their associated contours, and (B) generates an aggregation of the contours for the similar images so as to produce the consensus contour or the consistency contour.

10. The computer system of claim 9, wherein the contours are aggregated by reconciling differences between the contouring actions of the different users who generated the similar images, or the same user who generated the similar images.

11. The computer system of claim 8, wherein the contour generator utility is further operable to calculate agreement/deviation measures, such as sensitivity, specificity and conformity, and display these measures for the user, thereby permitting the user to evaluate the degree of deviation of the user created contour from the consensus contour or the consistency contour, wherein this information enables guidance of contouring decisions of the user.

12. The computer system of claim 1, wherein the server computer is configured to initiate updates to the atlases.

13. The computer system of claim 2, wherein personalized atlases for each user are created and made available by the computer system, including atlases of gray-intensity or binary or quasi-binary representations of images or parts of them, along with the associated the user-approved contours, and wherein the atlases are stored using a central computer or a distributed architecture linked to the computer system, wherein:
(a) the consensus contour or the consistency contour is requested by the user for consistency verification of the contour created by the user; and
(b) the use of the consensus contour built by the system provides automated consistency verification.

14. The computer system of claim 8, wherein the contour generator utility enables the extraction of contouring insights across multiple users and presentation of the contouring insights in connection with the user image contouring actions.

15. The computer system of claim 1, further comprising a learning utility that is operable to analyze contouring actions and/or contouring preferences of the user in order to improve the matching of the user created image/contour to available to available images/contours based on relevancy.

16. The computer system of claim 15, wherein the contour generator utility is associated with a viewing/editing dashboard that enables the user to generate more accurate contours, including by using one or more intelligent features integrated to the dashboard that are linked to the learning utility.
